(19) United States
(12) Patent Application Publication
(10) Pub. No.: US 2018/0139836 A1
(43) Pub. Date: May 17, 2018

(54) METHOD FOR OPERATING A LINEAR ACCELERATOR, LINEAR ACCELERATOR, AND MATERIAL-DISCRIMINATING RADIOSCOPY DEVICE

(71) Applicant: SIEMENS HEALTHCARE GMBH, ERLANGEN (DE)

(72) Inventors: MARTIN KOSCHMIEDER, RUDOLSTADT (DE); MARVIN MOELLER, JENA (DE); SVEN MUELLER, URBICH (DE); STEFAN WILLING, RUDOLSTADT (DE)

(21) Appl. No.: 15/813,860

(22) Filed: Nov. 15, 2017

(30) Foreign Application Priority Data
Nov. 15, 2016 (DE) 10 2016 222 373.9

(51) Int. Cl. H05H 7/02; H05H 9/04; G01V 5/00

(52) U.S. Cl. CPC H05H 7/02; H05H 9/04; H05H 2007/025; H05H 2007/022; G01V 5/0016

(57) ABSTRACT

A linear accelerator is operated by emitting charged particles from a particle source and accelerating the particles in an accelerator by wayof a high-frequency alternating field in such a way that pulses of charged particles are generated. A high-frequency power is periodically supplied by way of high-frequency pulses to the accelerator in order to generate the high-frequency alternating field. A particle stream emitted by the particle source is varied during a HF pulse length of the high-frequency pulse in such a way that the pulse formed during the HF pulse length has at least two sub-pulses with different mean energies per particle. There is also described a linear accelerator that carries out the method and a material-discriminating radioscopy device with a linear accelerator of this kind.

### CROSS-REFERENCE TO RELATED APPLICATION

This application claims the benefit, under 35 U.S.C. § 119, of German patent application DE 10 2016 222 373.9, filed Nov. 15, 2016; the prior application is herewith incorporated by reference in its entirety.

### BACKGROUND OF THE INVENTION

### Field of the Invention

The invention relates to a method for operating a linear accelerator, wherein charged particles are emitted by a particle source and are accelerated in an accelerator by means of a periodically applied, high-frequency alternating field in such a way that pulses of charged particles are generated, in particular in the MeV range.

It is known to use linear accelerators, in particular linear accelerators for electrons, in order to generate X-ray radiation in the MeV range, for example in the field of radiotherapy. A further field of application relates to non-destructive material testing or X-raying objects in particular in the context of a security check. In the latter case, X-ray systems are known for X-raying large objects, such as, for example freight containers for railroad cars, in which linear accelerators are used to generate photons in the MeV range. The X-ray radiation attenuated during penetration of the object is detected in a spatially resolved manner by an X-ray detector which is conventionally designed as a line detector. The radioscopic image of the object is therefore recorded line-by-line while the object is conveyed past the X-ray detector.

Recently, for example S. Ogorodnikov and V. Petrunin, have proposed in Physical Review Special Topics—Accelerators and Beams, Vol. 5, 104701 (2002) or in U.S. Pat. No. 8,183,801 B2, using particle pulses having different energies, for example having mean energies per particle of 4 MeV and 8 MeV, for material discrimination. The delay between successive pulse events is specified by the pulse repetition rate of the linear accelerator and lies in the range of several milliseconds. Image data having material information can be derived from the successively detected X-ray data by considering the intensity ratio corresponding to lines of different energy. Since low- and high-energy radiation is detected with a delay, artifacts are generated in the image data if the X-ray detector and the object are moved relative to each other during detection. In practical applications, for example freight containers or freight wagons of moving trains are X-rayed, so a measurement offset is produced which typically results in the range of several centimeters.

One approach for avoiding the problem, pursued in U.S. Pat. No. 5,524,133, consists in arranging a plurality of detectors side by side in rows, with one row of detectors respectively detecting a particular spectral fraction of a beam source having a fixed energy spectrum. The spectral fraction is selected, for example, by way of appropriate pre-filtering. This procedure is very expensive, however, since the number of required detectors is significantly increased.

U.S. patent application US 2014/0270086 A1 takes a different approach. There it is proposed that the electron inclusion is synchronized in an accelerator of the linear accelerator. The energy of the electron beam can then be varied in that the inclusion is shifted relative to the phase of the high-frequency alternating field prevailing within cavity resonators of the accelerator. Expenditure is significantly increased here as well since the linear accelerator has to be provided with a separate buncher section, for which a separate high-frequency amplifier stage is required.

### SUMMARY OF THE INVENTION

It is accordingly an object of the invention to provide a linear accelerator and a method for operating it which overcome the above-mentioned and other disadvantages of the heretofore-known devices and methods of this general type and which provide for a method and a device that are capable of ensuring the detection of high-quality material-discriminating radioscopic images.

With the foregoing and other objects in view there is provided, in accordance with the invention, a method for operating a linear accelerator, the method comprising:

emitting charged particles by a particle source;

periodically supplying a high-frequency power to an accelerator by way of high-frequency pulses in order to generate a high-frequency alternating field and accelerating the charged particles in the accelerator by the high-frequency alternating field to thereby generate pulses of charged particles; and

varying a particle stream emitted by the particle source during an HF pulse length of a high-frequency pulse in such a way that the pulse formed during the HF pulse length has at least two sub-pulses with mutually different mean energies per particle.

In the novel method for operating a linear accelerator, charged particles are emitted by a particle source and are accelerated in an accelerator by means of a high-frequency alternating field in such a way that pulses of charged particles are generated. A high-frequency power is periodically supplied to the accelerator by means of high-frequency pulses in order to generate the high-frequency alternating field. According to the invention, a particle stream emitted by the particle source is varied during an HF pulse length of the high-frequency pulse in such a way that the pulse formed during the HF pulse length has at least two sub-pulses with different mean energies per particle.

The invention therefore proposes achieving at least two sub-pulses having different mean energies during the HF pulse length of the high-frequency pulse. The HF pulse length of the high-frequency pulse typically lies in the range of a few microseconds. Known methods are based on detecting pulses of charged particles with which successive high-frequency pulses are associated. The interval between these pulses of charged particles is therefore specified by the repetition rate of the high-frequency pulses and is typically a few milliseconds. In other words, the measurement offset can be reduced by a factor of about 1,000 if events are read out which correspond to sub-pulses generated during the HF pulse length of the high-frequency pulse.

The invention is also based on the observation that the mean energy of the particles accelerated by means of the linear accelerator depends on the particle stream which is emitted by the particle source and therefore injected or “shot” into the accelerator. An “injection stream” is also referred to in this context. It is therefore possible to generate, for example, two sub-pulses by injecting two streams into the accelerator during the HF pulse length of the high-frequency pulse.

In order to ensure that the particles contained in the sub-pulses have different mean energies, firstly, in particular the stream strength of the emitted particle stream, which is also called, inter alia, a beam current or beam load, is adjusted therefore. In addition, the ability of the accelerator to store energy can be utilized. Since the accelerator of the linear accelerator has a resonator structure, the full acceleration voltage is typically not yet initially available (fill time), in other words, during an oscillation phase, as the high-frequency power is being supplied. Accordingly, the energy stored in the resonator structure typically decreases exponentially if the supply of high-frequency power is interrupted at the end of the high-frequency pulse. The mean energy of the particles contained in the respective sub-pulses can therefore also be adjusted by a variation in the time at which the particle stream is introduced or “shot” into the accelerator. This enables, in particular, flexible adjustment of X-ray radiation, generated by means of the sub-pulses, in respect of its photon energy or the dose imparted by the X-ray radiation.

The stream strength of the particle stream introduced into the accelerator—in other words the beam load—is preferably selected as a function of the time of introduction in such a way that the dose imparted by the at least two sub-pulses is constant and the energy difference between the two sub-pulses is maximal.

Several advantages are achieved by the invention therefore. Firstly, the at least two pulse events or sub-pulses, on which acquisition of a radioscopic image having material discrimination can be based, are typically delayed by only microseconds. This enables a reduction in image artifacts during scanning of fast-moving objects. Secondly, faster image acquisition is possible, and this is increased by the number of sub-pulses generated during the HF pulse length of the high-frequency pulse. The acquisition rate corresponds to a detector arrangement having a correspondingly increased number of X-ray detectors, so, for example with two sub-pulses per high-frequency pulse, two time-synchronous image acquisitions are possible with only one X-ray detector in the case of different mean energies. An increase in the mean high-frequency power that typically limits the image repetition rate is similarly not necessary for this.

In a preferred embodiment of the invention, the charged particles are electrons.

At least two sub-pulses time-delayed by about 1 μs to 3 μs are particularly preferably generated in that the stream strength of the particle stream is changed during the HF pulse length of the high-frequency pulse. When detecting moving objects, which move at a relative speed of about 60 kilometers per hour relative to the linear accelerator, a measurement offset results which lies in the range of about 15 μm to 50 μm. This enables, in particular, the acquisition of radioscopic X-ray images having material information on moving trains.

In preferred exemplary embodiments the HF pulse length of the high-frequency pulse is between 2 μs and 10 μs.

The mean energy per particle, which corresponds to the photon energy of the X-ray radiation generated by the sub-pulses, is preferably in a range of more than 1 MeV and less than 20 MeV. In other words, particle pulses are preferably generated with which bremsstrahlung or X-ray radiation can be generated in a spectral range which is suitable for X-raying massive containers, such as, in particular, the freight containers or railroad cars common in goods traffic.

A particle stream is preferably injected into the accelerator during an oscillation phase in order to generate one of the at least two sub-pulses. The full acceleration voltage is not yet available during the oscillation phase, with this voltage being reduced again by the introduced particle stream. A sub-pulse having low mean energy per particle can therefore be generated by introducing the particle stream at a time before the acceleration voltage has reached its saturation value.

The pulse of charged particles containing the at least two sub-pulses is particularly preferably used for generating X-ray radiation, in particular for generating X-ray radiation for radioscopy, in other words the generation of X-ray images. Other fields of application relate, for example, to radiotherapy or computerized tomography. Here, material discrimination is an additional item of information which can be directly acquired in a scanning process. This therefore avoids the requirement of having to perform a plurality of scans with different energy spectra in order to obtain information about the material composition of the X-rayed object.

Particularly preferred exemplary embodiments relate to the acquisition of material-discriminating radioscopic images of objects. For this purpose, the pulse of charged particles is decelerated to provide X-ray radiation with a different spectral composition. The material-discriminating radioscopic images are generated by means of an X-ray detector which detects the X-ray radiation following penetration of the object.

The X-ray detector is particularly preferably designed as a line detector, in other words, the X-ray detector comprises a large number of individual detectors arranged side by side, enabling simultaneous detection of X-ray radiation in the direction specified by the linear arrangement of individual detectors. A design of this kind should be given preference, in particular when X-raying large objects.

The object and the X-ray detector preferably move relative to each other during acquisition of the radioscopic images. With the design as a line detector, the object also preferably moves in a direction running perpendicular to the linear arrangement of individual detectors. Due to the short time delay between the sub-pulses contained in the pulse, image artifacts can largely be avoided when detecting moving objects.

The object mentioned in the introduction is also achieved by a linear accelerator which is designed to be operated with the method described above. The technical advantages associated therewith result directly from the above description, so reference is firstly made hereto in order to avoid repetitions.

With the above and other objects in view there is also provided, in accordance with the invention, a linear accelerator, comprising:

a particle source for emitting a particle stream;

an accelerator having a plurality of cavity resonators that are coupled to one another, said accelerator being configured to periodically receive a high-frequency power by way of high-frequency pulses having a HF pulse length in order to generate a high-frequency alternating field;

a controller connected to said particle source and configured to vary a particle stream emitted by said particle source during an HF pulse length of the high-frequency pulse in such a way that a pulse of charged particles formed during the HF pulse length has at least two sub-pulses having mutually different mean energies per particle.

In other words, the novel linear accelerator comprises a particle source that emits a particle stream, and an accelerator comprising a plurality of cavity resonators that are coupled to each other. A high-frequency power can periodically be supplied by means of high-frequency pulses having an HF pulse length in order to generate a high-frequency alternating field. According to the invention, a controller is designed to vary a particle stream emitted by the particle source during an HF pulse length of the high-frequency pulse in such a way that the pulse formed during the HF pulse length has at least two sub-pulses having different mean energies per particle.

A radioscopic image with material discrimination can be acquired on the basis of the at least two pulse events or sub-pulses. Since these events are time-delayed by only a few microseconds, image artifacts can largely be eliminated, in particular during detection of moving objects.

The linear accelerator designed in this way also enables faster image acquisition since a plurality of sub-pulses are now available during the HF pulse length of the high-frequency pulse, and these can be used to generate X-ray radiation in an imaging device. A modification of the particle source feeding the particle stream, or its activation, is crucial for this, and this is possible by way of an adjustment of the corresponding electronic components of the controller.

With the above and other objects in view there also is provided, in accordance with the invention, a material-discriminating radioscopy device, comprising:

an X-ray emitter and an X-ray detector disposed to form an intermediate region for introducing an object to be X-rayed between said X-ray emitter and said X-ray detector;

said X-ray emitter having a linear accelerator as outlined above for subjecting a target to pulses of charged particles; and

an evaluation device configured to generate radioscopic images from data detected by way of said X-ray detector.

In other words, material-discriminating radioscopy device comprises an X-ray emitter, an X-ray detector and an evaluation device for generating radioscopic images from the data detected by means of the X-ray generator. An object to be X-rayed should be introduced into an intermediate region between X-ray emitter and X-ray detector for this purpose. According to the invention, the X-ray emitter has the linear accelerator described above, which is designed to load a target with pulses of charged particles in order to thereby generate bremsstrahlung in spectral ranges which correspond to the mean energies of the particles contained in the sub-pulses.

The material-discriminating radioscopy device is suitable, for example for security checks in particular of luggage. The device is particularly preferably used for checking goods traffic. The device is preferably designed to X-ray large objects, such as shipping containers, and in one possible embodiment of the invention comprises for this purpose an X-ray detector designed as a line detector.

Other features which are considered as characteristic for the invention are set forth in the appended claims.

Although the invention is illustrated and described herein as embodied in a method for operating a linear accelerator and linear accelerator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows the schematic construction of a material-discriminating radioscopy device having a linear accelerator;

FIG. 2 shows the progression of a method for the operation of the linear accelerator;

FIG. 3 shows the acceleration voltage as a function of time in an exemplary embodiment having eight coupled cavity resonators; and

FIG. 4 shows the acceleration voltage as a function of time in a further exemplary embodiment having 22 coupled cavity resonators.

### DETAILED DESCRIPTION OF THE INVENTION

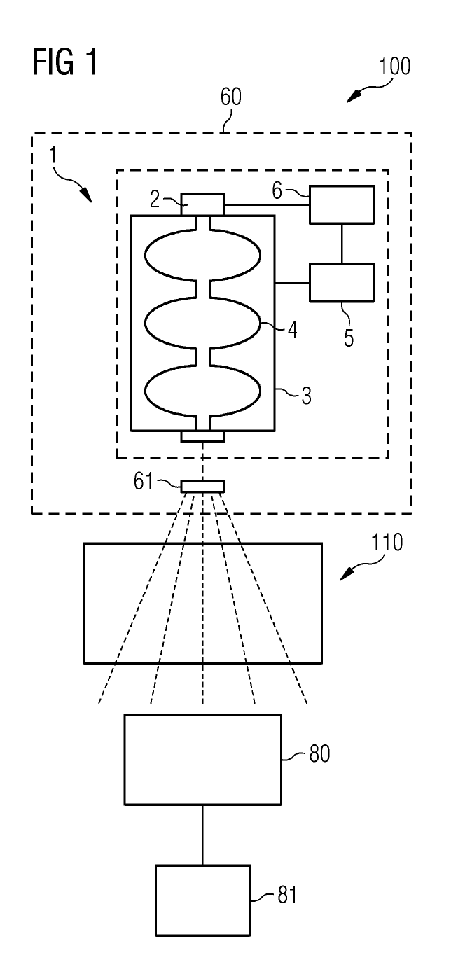

Referring now to the figures of the drawing in detail and first, particularly, to FIG. 1 thereof, there is shown a schematic of the construction of an imaging material-discriminating radioscopy device 100. The device 100 is designed to acquire radioscopic X-ray images of large objects 110, such as, in particular, freight containers, and has for this purpose an X-ray emitter 60 and an X-ray detector 80. The object 110 to be X-rayed is arranged in the intermediate region between the X-ray emitter 60 and X-ray detector 80. The X-ray detector 80, which is designed, for example, as a line detector, detects the X-ray radiation attenuated during penetration through the object 110. In a manner known per se, an evaluation device 81 generates a radioscopic image on the basis of the detected attenuation data.

The device 100 is designed to provide information about the material composition of the X-rayed object. The X-ray emitter 60 emits for this purpose delayed photons having different energy. Conclusions about the radiographed object can be made from the intensity ratio, detected by the X-ray detector 80, of the attenuation data corresponding to the different radiation energies Eₚₕ. The radiation energy Eₚₕ per emitted photon is, for example, about 4 MeV and about 8 MeV.

The X-ray emitter 60 has for this purpose a target 61 which is loaded by pulses of charged particles, so bremsstrahlung having the required spectral fractions results. The pulse of charged particles—in the present case these are electrons—can be generated by means of the linear accelerator 1, which comprises a particle source 2 and an accelerator 3 having a plurality of coupled cavity resonators 4. An energy supply 5 supplies the accelerator 3 with a high-frequency power P_{HF} in order to generate a high-frequency alternating field inside the coupled cavity resonators 4 for accelerating a particle stream, which stream is shot or injected by the particle source 2 into the accelerator at specified times.

The high-frequency power P_{HF} is supplied periodically, in other words, in the form of high-frequency pulses supplied by the accelerator 3 and which have a HF pulse length Δt. A controller 6 is connected to the particle source 2 and the energy supply 5 and is designed to synchronize coupling or “shooting” of the particle streams into the accelerator 3 in respect of the periodically supplied high-frequency power P_{HF}. The controller 6 and the particle source 2 are designed in particular to introduce at least two particle streams having different stream strengths I into the accelerator 3 during HF pulse length Δt, which is typically in the range of a few microseconds.

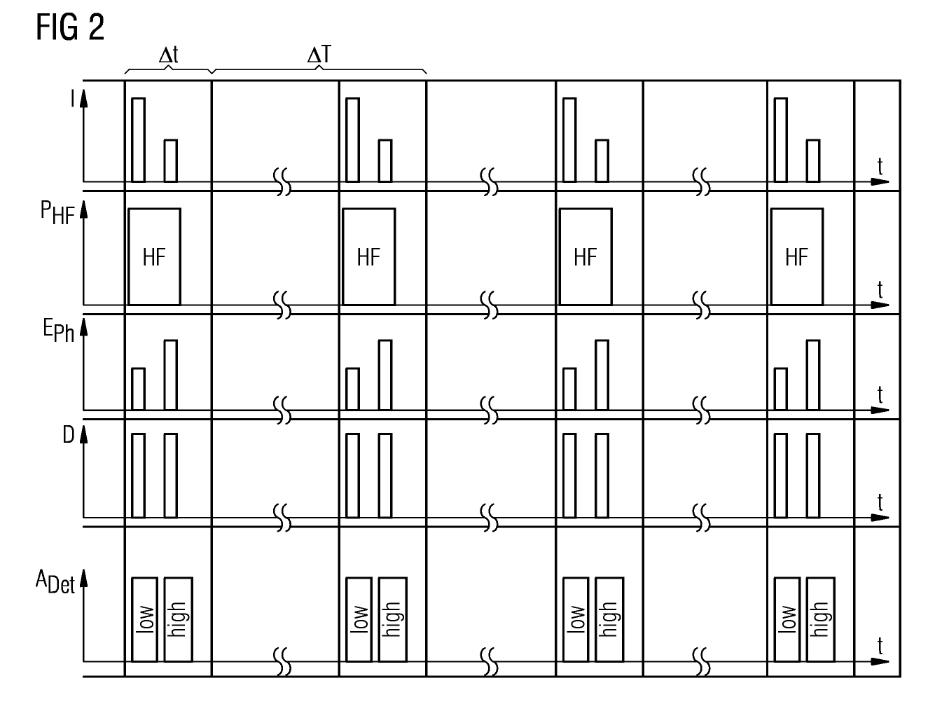

FIG. 2 schematically illustrates the method for operation of the linear accelerator 1 using a plurality of function graphs which illustrate various physical variables or operating parameters as a function of time t.

The high-frequency pulse supplied to the accelerator 3 has an HF pulse length Δt which is between 3 and 5 μs. The period length ΔT is in the range of milliseconds, in the illustrated example these are 2 to 3 ms.

Two sub-pulses of charged particles are generated during the time window specified by the HF pulse length Δt by injecting two particle streams having different stream strengths I into the accelerator 3. Since in an oscillation phase at the beginning of the high-frequency pulse the maximum acceleration voltage of the oscillated state is not yet available in the resonator structure formed by the coupled cavity resonators 4, the particles contained in the first sub-pulse have a lower mean energy. The X-ray radiation generated thereby accordingly has a lower radiation energy Eₚₕ per photon.

The stream strengths I of the two particle streams injected during the HF pulse length Δt are selected such that the deposited dose D is the same for the two sub-pulses. The detector read out A_{Det} of the low-energy or high-energy sub-pulse accordingly takes place delayed by about 1 to 2 μs.

The conversion of at least two sub-pulses having different mean energies per particle during the HF pulse length Δt of a high-frequency pulse is based on the property of the accelerator being able to store energy. The change in energy W_{B} in the resonator structure of the accelerator 3 is given by

$$\frac{{dW}_{B}}{dt} = {P}_{HF} - {P}_{ohm} - {P}_{beam} ,$$

where Pₒₕₘ are the ohmic losses of the standing wave in the accelerator 3 and P_{beam} the beam losses. The acceleration voltage U results from the energy W_{B} stored in the resonator structure according to

$${W}_{B} = \frac{1}{2} {C}_{B} {U}^{2} .$$

The capacity C_{B} of the accelerator 3 is the coupling factor between the square of the acceleration voltage U and the stored energy W_{B}. For the total capacity C_{B} of the accelerator 3, the following roughly applies

$${C}_{B} = \frac{{C}_{1 cell}}{N} ,$$

where C_{1cell} designates the capacity of a cavity resonator 4.

The ohmic losses

$${P}_{ohm} = \frac{{U}^{2}}{{R}_{S}}$$

are described by the shunt resistance Rₛ. The shunt resistance R_{S1cell} of an accelerator 3 having N coupled cavity resonators 4 is

R_{S}=N·R_{S1cell}

The beam losses P_{beam} are given by the product of the acceleration voltage U and the stream strength I.

These assumptions show that the acceleration voltage U is proportional to the root of the number N of coupled cavity resonators. Furthermore, the dependence of the acceleration voltage U on the stream strength I increases as N increases since the shunt resistance decreases.

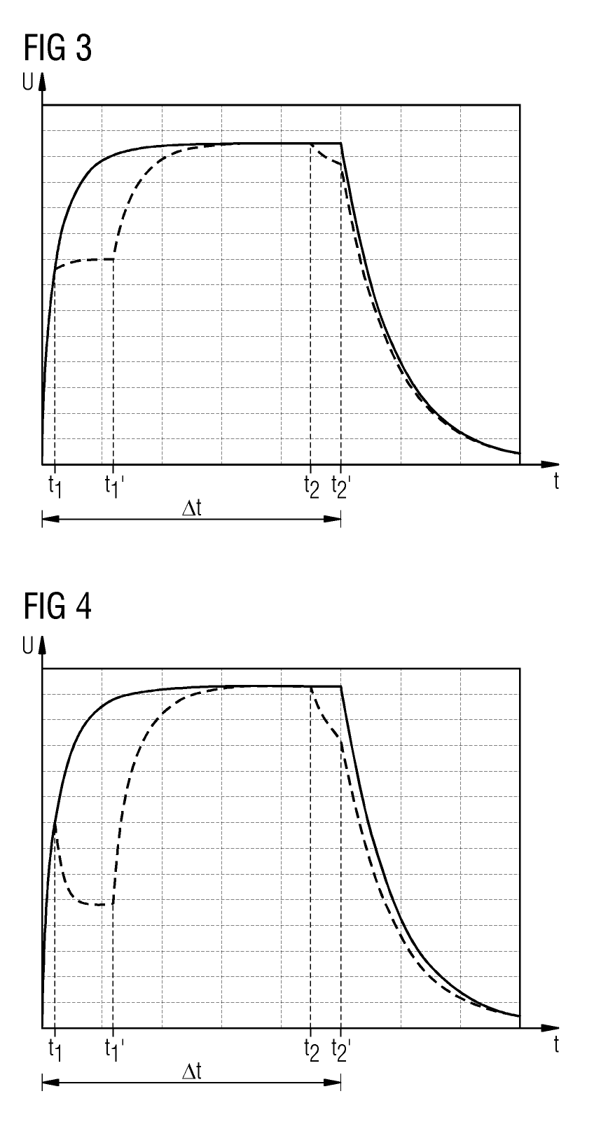

FIGS. 3 and 4 show simulation results for accelerators 3, which have 8 (FIG. 3) or 22 coupled cavity resonators 4 (FIG. 4). The course of the acceleration voltage U as a function of time t without injected particle stream is given in both cases by the solid line. The course of the acceleration voltage U as a function of time t with injected particle streams is given by the broken line. In both cases one particle stream is in each case injected at time t₁ and t₂ respectively into the accelerator 3, and this is switched off again at time t₁′ or t₂′. In both cases the simulation result show that less acceleration voltage U is applied if a particle stream is introduced into the cavity resonators 4.

The time t₁ is also chosen, moreover, such that it lies within an oscillation phase of the resonator structure formed by the cavity resonators 4. In other words, the acceleration voltage U at this time t1 has still not reached its saturation value, so the particles contained in the first sub-pulse undergo a lower growth in kinetic energy.

Although the invention has been illustrated and described in detail with reference to the preferred exemplary embodiment, the invention is not limited hereby. A person skilled in the art can derive other variations and combinations herefrom without deviating from the fundamental concept of the invention.

1. A method for operating a linear accelerator, the method comprising:
emitting charged particles by a particle source;
periodically supplying a high-frequency power to an accelerator by way of high-frequency pulses in order to generate a high-frequency alternating field and accelerating the charged particles in the accelerator by the high-frequency alternating field to thereby generate pulses of charged particles; and
varying a particle stream emitted by the particle source during an HF pulse length of a high-frequency pulse in such a way that the pulse formed during the HF pulse length has at least two sub-pulses with mutually different mean energies per particle.

2. The method according to claim 1, which comprises generating at least two sub-pulses time-delayed by about 1 μs to 3 μs by changing a stream strength of a particle stream during the HF pulse length of the high-frequency pulse.

3. The method according to claim 1, wherein the HF pulse length of the high-frequency pulse lies between 2 μs and 10 μs.

4. The method according to claim 1, wherein a mean energy per particle lies within a range of more than 1 MeV and less than 20 MeV.

5. The method according to claim 1, which comprises injecting a particle stream into the accelerator during an oscillation phase in order to generate one of the at least two sub-pulses.

6. The method according to claim 1, which comprises using a pulse of charged particles containing the at least two sub-pulses for generating X-ray radiation.

7. The method according to claim 6, which comprises generating material-discriminating radioscopic images of an object by way of an X-ray detector that detects the X-ray radiation.

8. The method according to claim 7, which comprises causing the object and the X-ray detector to move relative to each other during acquisition of the radioscopic images.

9. A linear accelerator, comprising:
a particle source for emitting a particle stream;
an accelerator having a plurality of cavity resonators that are coupled to one another, said accelerator being configured to periodically receive a high-frequency power by way of high-frequency pulses having a HF pulse length in order to generate a high-frequency alternating field;
a controller connected to said particle source and configured to vary a particle stream emitted by said particle source during an HF pulse length of the high-frequency pulse in such a way that a pulse of charged particles formed during the HF pulse length has at least two sub-pulses having mutually different mean energies per particle.

10. A material-discriminating radioscopy device, comprising:
an X-ray emitter and an X-ray detector disposed to form an intermediate region for introducing an object to be X-rayed between said X-ray emitter and said X-ray detector;
said X-ray emitter having a linear accelerator according to claim 9 configured to load a target with pulses of charged particles; and
an evaluation device configured to generate radioscopic images from data detected by way of said X-ray detector.
